(19) United States
(12) Patent Application Publication
(10) Pub. No.: US 2023/0288022 A1
(43) Pub. Date: Sep. 14, 2023

(54) ACCESSORY FIXING MODULE FOR BICYCLE HANDLEBAR

(71) Applicant: HSIN LUNG ACCESSORIES CO., LTD., Hsin-Chu Hsien (TW)

(72) Inventor: Xue-Sen LIAO, Hsin-Chu Hsien (TW)

(21) Appl. No.: 17/751,772

(22) Filed: May 24, 2022

(30) Foreign Application Priority Data
Mar. 10, 2022 (TW) 111202426

(51) Int. Cl. F16M 13/02; B62J 11/00

(52) U.S. Cl. CPC F16M 13/022; B62J 11/00

(57) ABSTRACT

The invention relates to an accessory fixing module adapted to connect an accessory to a bicycle handlebar. The accessory fixing module includes a fastening member and a hanger. The fastening member has a ring part adapted to sleeve onto the bicycle handlebar, and the ring part is provided at one side thereof with a fixing portion. The hanger includes a first connector part for connection to the fixing portion, a second connector part adapted for connection to an accessory, and a bracket part linking the first connector part to the second connector part. The bracket part includes a first longitudinal frame body, a second longitudinal frame body, and a transverse frame body linking the first longitudinal frame body to the second longitudinal frame body. The first and second longitudinal frame bodies are arranged at a fixed angle with respect to the transverse frame body.

### CROSS REFERENCE TO RELATED APPLICATION

This application claims priority to R.O.C. Utility Model Application No. 111202426 filed Mar. 10, 2022, which is hereby incorporated by reference in their entirety.

### FIELD OF THE INVENTION

The invention relates to an accessory fixing module and, more particularly, to an accessory fixing module adapted for conveniently and quickly assembling accessories on a bicycle handlebar for versatile mounting of a variety of accessories.

### BACKGROUND OF THE INVENTION

Bicycles are a commonly used means of transportation. Its power source comes from pedaling by human force and does not need electricity or gasoline, making it very environmentally friendly and suitable for serving as a general tool of transportation or a leisure sports equipment. Since riding bicycles has been promoted for its recreation and environmental benefits, more and more people are selecting it for transportation. Further, with the growth of the bicycle market, various electronic accessories, such as bike lights, stopwatches, mobile phone holders, dashboard cameras, display screens and action camcorders, were developed for being mounted on the stem tubes or handlebars of bicycles, so as to allow riders to monitor their exercise data and physical conditions and/or receive useful information, such as riding paths and weather reports, by operating these accessories.

Electronic accessories are usually assembled onto bicycles using fixtures. A conventional type of fixtures includes a fixture base adapted for connection to the stem tube and a quick-release fastener on which an electronic accessory or a protective case for housing the electronic accessory may be bonded with a double-sided tape. By virtue of the quick releasability of the fastener from the fixture base, the electronic accessory can be quickly mounted on or detached from the stem tube. However, since the fastener in the conventional fixtures of this type is merely connected to the electronic accessory or the protective case with a double-sided tape, such connection could easily come loose to incur damage to the electronic accessory when the bicycle is riding on an uneven path or passing through large potholes and thus continuing to bump up and down at high-frequency.

### SUMMARY OF THE INVENTION

In view of the above drawbacks, an object of the invention is to provide an accessory fixing module and, more particularly, an accessory fixing module adapted for conveniently and quickly assembling accessories onto a bicycle handlebar for versatile mounting of a variety of accessories.

Therefore, in an aspect provided herein is an accessory fixing module, which comprises a fastening member comprising a ring part adapted for sleeving on the bicycle handlebar, wherein the ring part is provided one side thereof with a fixing portion; and a hanger comprising a first connector part for connection to the fixing portion, a second connector part adapted for connection to an accessory, and a bracket part linking the first connector part to the second connector part, wherein the bracket part comprises a first longitudinal frame body, a second longitudinal frame body, and a transverse frame body linking the first longitudinal frame body to the second longitudinal frame body, and wherein the first and second longitudinal frame bodies are arranged at a fixed angle with respect to the transverse frame body.

In a preferred embodiment, the second connector part is configured in a tubular form.

In a preferred embodiment, the accessory fixing module further comprises a nesting body which is formed with a sleeving hole for sleeving onto and connecting with the second connector part.

In a preferred embodiment, the accessory fixing module further comprises an extension tube provided with at least two snap pins. The second connector part is formed on its wall with at least two snap holes to receive the snap pins of the extension tube.

In a preferred embodiment, the bicycle handlebar is a curved handlebar.

In a preferred embodiment, the fixing portion is provided with teeth for engaging with teeth formed on the first connector part.

In a preferred embodiment, the fastening member is formed with a threaded hole for receiving a bolt.

In a preferred embodiment, the first connector part is formed with a through hole via which the bolt may be inserted.

In a preferred embodiment, the fastening member comprises a ring seat, on which the ring part is disposed, and a coupling seat, on which the fixing portion is disposed.

In a preferred embodiment, the ring seat is formed with a threaded hole for receiving the bolt.

In a preferred embodiment, the fixed angle is 90 degrees.

### BRIEF DESCRIPTION OF THE DRAWINGS

FIG. 1 is a perspective exploded structural view of an accessory fixing module according to the first embodiment of the invention;

FIG. 2 is a perspective structural view of an accessory fixing module according to the second embodiment of the invention;

FIG. 3 is an exploded structural view of the accessory fixing module according to the second embodiment of the invention;

FIG. 4 is an enlarged structural view of the accessory fixing module according to the second embodiment of the invention;

FIG. 5 is a perspective structural view of an accessory fixing module according to the third embodiment of the invention; and

FIG. 6 is an exploded structural view of the accessory fixing module according to the third embodiment of the invention.

### DETAILED DESCRIPTION OF THE PREFERRED EMBODIMENTS

In order to facilitate the examiner's understanding of the technical features, content and advantages of the invention and the efficacies it can achieve, the invention will be described in detail as follows in the form of embodiments and with reference to the accompanying drawings. The drawings used herein are merely for the purpose of illustration and supplement for the invention, and may not be the true proportions and precise configurations after the invention is implemented. Therefore, relationships between the proportions and configurations of the attached drawings should not be used to interpret or limit the scope of claims in the actual implementation.

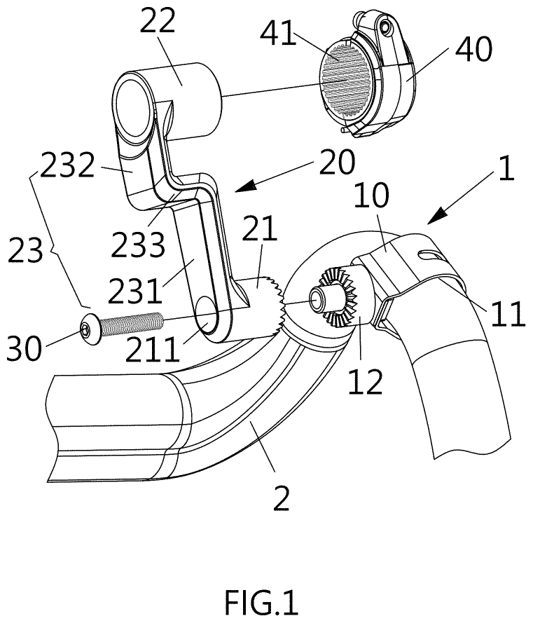

FIG. 1 is a perspective exploded structural view of an accessory fixing module according to the first embodiment of the invention. As shown, the accessory fixing module 1 is adapted to connect an accessory to a handlebar 2 of a bicycle, which may by way of example be a curved handlebar. The accessory fixing module 1 comprises a fastening member 10 and a hanger 20.

The fastening member 10 comprises a ring part 11 adapted for sleeving on the handlebar 2, and the ring part 11 is provided at one side with a fixing portion 12. According to the embodiment shown in the figure, the fixing portion 12 may be integrally formed on one side of the ring part 11. The fastening member 10 may be formed with a threaded hole (not shown) for receiving a bolt 30. The hanger comprises a first connector part 21 for connection to the fixing portion 12, a second connector part 22 adapted for connection to an accessory, and a bracket part 23 linking the first connector part 21 to the second connector part 22. The bracket part 23 includes first and second longitudinal frame bodies 231, 232 and a transverse frame body 233 linking the first longitudinal frame body 231 to the second longitudinal frame body 232. The first and second longitudinal frame bodies 231, 232 are arranged at a fixed angle with respect to the transverse frame body 233. In the embodiment shown in the figure, the first connector part 21 is formed with a through hole 211. The first longitudinal frame body 231 extends from the first connector part 21 in a longitudinal direction, whereas the transverse frame body 233 extends in a traverse direction from the opposite end of the first longitudinal frame body 231. The longitudinal direction is perpendicular to the direction that the through hole 211 extends, whereas the traverse direction is parallel to the direction that the through hole 211 extends. In one embodiment, the fixed angle between the first longitudinal frame body 231 and the transverse frame body 233, as well as the fixed angle between the second longitudinal frame body 232 and the transverse frame body 233, are both 90 degrees. In one embodiment, the second connector part 22 is configured in a tubular form.

According to the invention, the ring part 11 may be sleeved around the handlebar 2 of the bicycle. The fixing portion 12 of the fastening member 10 may be attached with the first connector part 21 of the hanger 20, and a bolt 30 may be inserted via the through hole 211 and engaged with the threaded hole, such that the accessory fixing module herein is assembled in position of use. Optionally, the tubular-shaped second connector part 22 may be coupled to at least one nesting body 40, which is formed with a sleeving hole 41 adapted to sleeve onto and connect with the second connector part 22 for mounting at least one accessory.

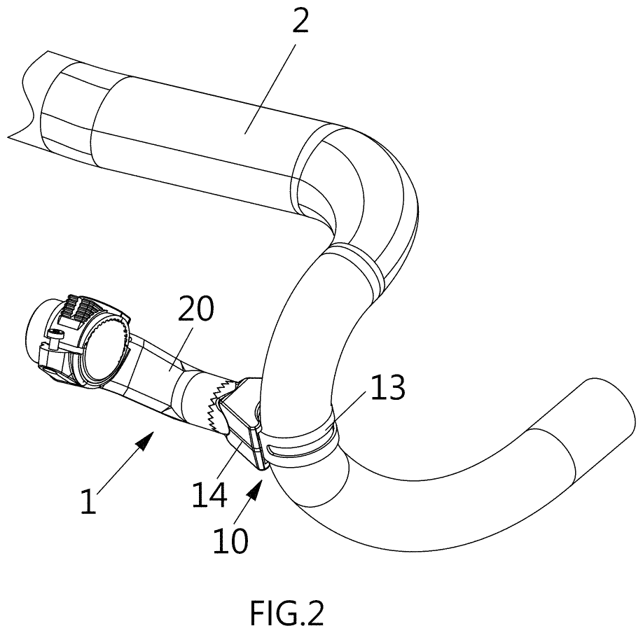

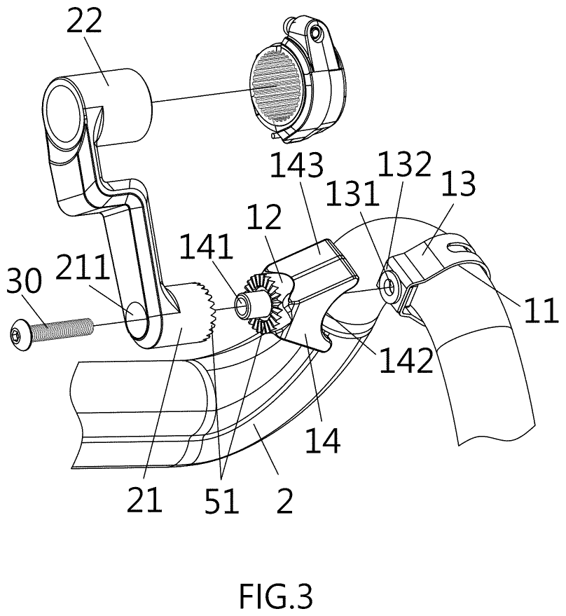

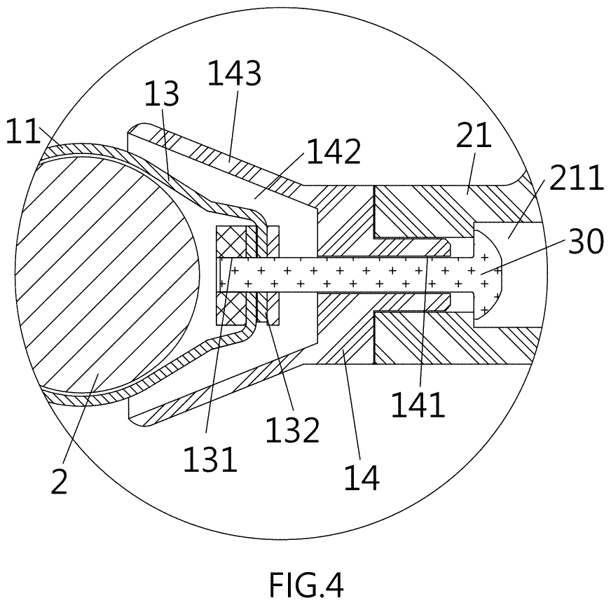

In the second embodiment shown in FIGS. 2-4, the fastening member 10 further comprises a ring seat 13 and a coupling seat 14, whereas the ring part 11 is disposed on the ring seat 13. The ring seat 13 is formed with a threaded hole 131 for receiving a bolt 30. The fixing portion 12 is disposed on the coupling seat 14. The coupling seat 14 is formed with a through hole 141 and a concave portion 142 for receiving an end portion 132 of the ring seat 13. The concave portion 142 is provided at both ends thereof with a covering side wall 143. During assembling, the ring part 11 of the ring seat 13 is sleeved around the handlebar 2 of the bicycle. The concave portion 142 of the coupling seat 14 is arranged to face the end portion 132 of the ring seat 13, with the covering side walls 143 covering the ring seat 13. The fixing portion 12 is attached with the first connector part 21 of the hanger 20, and the bolt 30 is inserted via the through hole 211 of the first connector part 21 and the through hole 141 of the coupling seat 14 to engage with the threaded hole 131, such that the accessory fixing module herein is assembled in position of use.

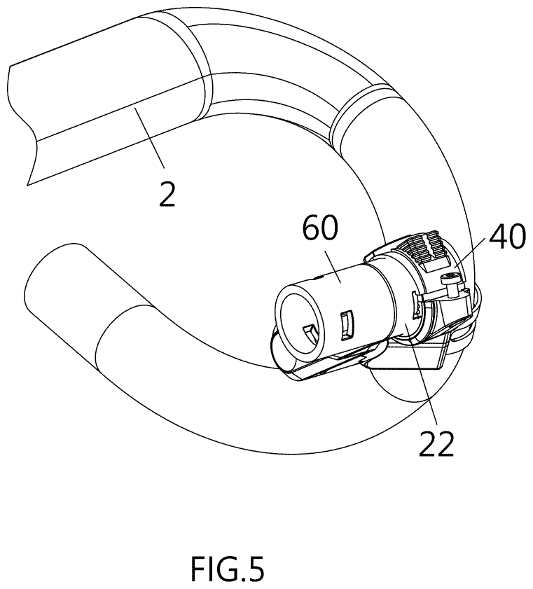

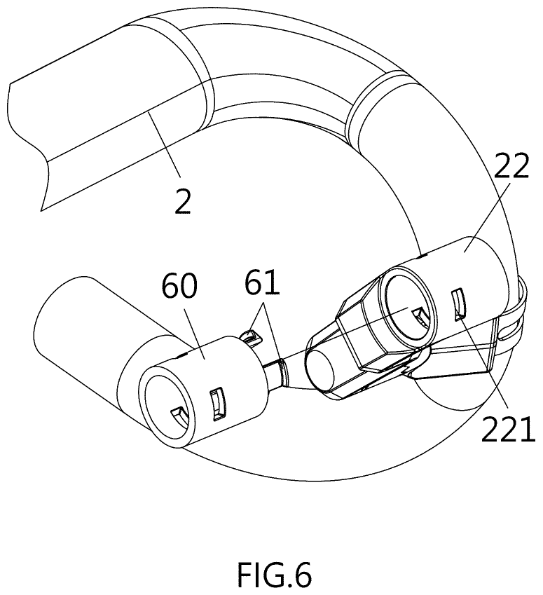

In the embodiments above, the fixing portion 12 is provided with teeth 51 for engaging with the teeth 51 of the first connector part 21. This structure allows the user to adjust the angle between the fastening member 10 and the hanger 20 by slightly withdrawing the bolt 30 from the threaded hole to disengage the teeth 51. The second connector part 22 may be further provided with an extension tube 60. As shown in FIGS. 5 and 6, the second connector part 22 is formed on the wall thereof with at least two snap holes 221 to receive snap pins 61 formed on the extension tube 60 for mounting additional accessories.

By virtue of the assembly disclosed above, the hanger 20 can be secured on the bicycle handlebar 2 for mounting a variety of accessories according to the rider's needs. It is important to note that the angle of the bracket part 23 (which includes the first and second longitudinal frame bodies 231, 232 and the transverse frame body 233 as described above) with respect to the fastening member 10 is adjustable, making the embodiment particularly suitable for use on a curved handlebar for versatile mounting of various accessories at the same time, thus improving usefulness.

The invention provides an improved accessory fixing module. While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An accessory fixing module for use on a bicycle handlebar, comprising:
a fastening member comprising a ring part adapted for sleeving on the bicycle handlebar, wherein the ring part is provided one side thereof with a fixing portion; and
a hanger comprising a first connector part for connection to the fixing portion, a second connector part adapted for connection to an accessory, and a bracket part linking the first connector part to the second connector part, wherein the bracket part comprises a first longitudinal frame body, a second longitudinal frame body, and a transverse frame body linking the first longitudinal frame body to the second longitudinal frame body, and wherein the first and second longitudinal frame bodies are arranged at a fixed angle with respect to the transverse frame body.

2. The accessory fixing module for use on the bicycle handlebar as claimed in claim 1, wherein the second connector part is configured in a tubular form.

3. The accessory fixing module for use on the bicycle handlebar as claimed in claim 2, further comprising a nesting body which is formed with a sleeving hole for sleeving onto and connecting with the second connector part.

4. The accessory fixing module for use on the bicycle handlebar as claimed in claim 2, wherein the fixing portion is provided with teeth for engaging with teeth formed on the first connector part.

5. The accessory fixing module for use on the bicycle handlebar as claimed in claim 2, wherein the fastening member is formed with a threaded hole for receiving a bolt.

6. The accessory fixing module for use on the bicycle handlebar as claimed in claim 5, wherein the first connector part is formed with a through hole, via which the bolt may be inserted.

7. The accessory fixing module for use on the bicycle handlebar as claimed in claim 2, wherein the fastening member comprises a ring seat, on which the ring part is disposed, and a coupling seat, on which the fixing portion is disposed.

8. The accessory fixing module for use on the bicycle handlebar as claimed in claim 7, wherein the ring seat is formed with a threaded hole for receiving the bolt.

9. The accessory fixing module for use on the bicycle handlebar as claimed in claim 2, further comprising an extension tube provided with at least two snap pins, wherein the second connector part is formed on its wall with at least two snap holes to receive the snap pins of the extension tube.

10. The accessory fixing module for use on the bicycle handlebar as claimed in claim 9, further comprising a nesting body which is formed with a sleeving hole for sleeving onto and connecting with the second connector part.

11. The accessory fixing module for use on the bicycle handlebar as claimed in claim 9, wherein the fixing portion is provided with teeth for engaging with teeth formed on the first connector part.

12. The accessory fixing module for use on the bicycle handlebar as claimed in claim 9, wherein the fastening member is formed with a threaded hole for receiving a bolt.

13. The accessory fixing module for use on the bicycle handlebar as claimed in claim 12, wherein the first connector part is formed with a through hole, via which the bolt may be inserted.

14. The accessory fixing module for use on the bicycle handlebar as claimed in claim 9, wherein the fastening member comprises a ring seat, on which the ring part is disposed, and a coupling seat, on which the fixing portion is disposed.

15. The accessory fixing module for use on the bicycle handlebar as claimed in claim 14, wherein the ring seat is formed with a threaded hole for receiving the bolt.

16. The accessory fixing module for use on the bicycle handlebar as claimed in claim 1, wherein the bicycle handlebar is a curved handlebar.

17. The accessory fixing module for use on the bicycle handlebar as claimed in claim 1, wherein the fixed angle is 90 degrees.
